(19) United States
(12) Patent Application Publication
(10) Pub. No.: US 2012/0050390 A1
(43) Pub. Date: Mar. 1, 2012

(54) WATER-BASED BLACK INK COMPOSITION FOR INK JET RECORDING AND IMAGE FORMING METHOD

(75) Inventor: Naoko NISHIMURA, Kanagawa (JP)

(73) Assignee: FUJIFILM CORPORATION, Tokyo (JP)

(21) Appl. No.: 13/186,477

(22) Filed: Jul. 20, 2011

(30) Foreign Application Priority Data
Aug. 27, 2010 (JP) 2010-191272

(51) Int. Cl. B41J 2/015; C08K 5/3417; C08K 5/23; C08K 5/3437

(52) U.S. Cl. 347/21; 524/90; 524/88; 524/190

(57) ABSTRACT

A water-based black ink composition for ink jet recording including: a carbon black pigment at least partially coated with a water-insoluble first dispersant polymer containing a structural unit represented by the following formula (1) and a structural unit different from the structural unit represented by the following formula (1); a coloring pigment selected from the group consisting of a phthalocyanine pigment, a quinacridone pigment and an azo pigment, the coloring pigment being at least partially coated with the first dispersant polymer or a second dispersant polymer consisting of the same structural units as the structural units constituting the first dispersant polymer but having a composition ratio of the structural units different from a composition ratio of the structural units of the first dispersant polymer; and an aqueous medium:

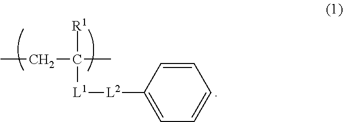

### CROSS-REFERENCE TO RELATED APPLICATION

This application claims priority under 35 USC 119 from Japanese Patent Application No. 2010-191272 filed on Aug. 27, 2010, the disclosure of which is incorporated by reference herein.

### BACKGROUND OF THE INVENTION

1. Field of the Invention

The invention relates to a water-based black ink composition for ink jet recording and a method of forming an image.

2. Description of the Related Art

Recently, a water dispersion having water-insoluble solid such as a pigment dispersed in water is widely used as ink for ink jet recording or the like.

As a pigment for constituting black ink, carbon black is used in many cases. However, black ink prepared using carbon black sometimes yields reddish black color tone in a region in which print density is low.

In this regard, various black ink compositions which can form a neutral black color by using a complementary color pigment have been developed. For example, there is disclosed an ink jet recording liquid containing carbon black and a water-insoluble phthalocyanine-based pigment, which allegedly has excellent water resistance, print density, and storage stability (for example, see Japanese Patent Application Laid-Open (JP-A) No. 7-268258).

There is further disclosed a black ink composition containing a phthalocyanine-based pigment, a benzimidazolone-based pigment, and a carbon black pigment, which can allegedly form a neutral black color (for example, see, JP-A No. 2005-29596).

Meanwhile, for ink jet ink containing an aqueous dispersion of a pigment, various polymer dispersants have been studied to improve dispersion stability of the pigment or the like. For example, a water-based ink for ink jet recording containing a pigment coated with water-insoluble polymer dispersant is disclosed which allegedly has excellent dispersion stability and jetting stability (for example, see, JP-A No. 2009-84494).

However, regarding the ink jet recording liquids of JP-A Nos. 7-268258 and 2005-29596, there is still room for an improvement in terms of forming an image having good color formation and color reproducibility. In some cases, the formed image is insufficient in resistance to abrasion. Also, the water-based ink for ink jet recording described in JP-A No. 2009-84494 requires further improvements since sometimes bluish black color tone is formed when the ink is dried.

### SUMMARY OF THE INVENTION

According to an aspect of the invention, there is provided a water-based black ink composition for ink jet recording comprising:

a carbon black pigment, at least a part of a surface of the carbon black pigment being coated with a water-insoluble first dispersant polymer containing a structural unit represented by the following formula (1) and a structural unit different from the structural unit represented by the following formula (1);

at least one coloring pigment selected from the group consisting of a phthalocyanine pigment, a quinacridone pigment and an azo pigment, at least a part of a surface of the at least one coloring pigment being coated with the first dispersant polymer or a second dispersant polymer consisting of the same structural units as the structural units constituting the first dispersant polymer but having a composition ratio of the structural units different from a composition ratio of the structural units of the first dispersant polymer; and

an aqueous medium:

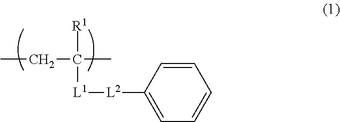

wherein R¹ represents a hydrogen atom, a methyl group, or a halogen atom; L¹ represents *—COO—, *—OCO—, *—CONR²—, *—O—, or a substituted or unsubstituted phenylene group; R² represents a hydrogen atom or an alkyl group having 1 to 10 carbon atoms; L² represents a single bond or a divalent linking group having 1 to 30 carbon atoms; and the symbol * in the group represented by L¹ represents a connecting point with a main chain of the first dispersant polymer.

### DETAILED DESCRIPTION OF THE INVENTION

<Water-Based Black Ink Composition for Ink Jet Recording>

The water-based black ink composition for ink jet recording (hereinafter, it may be simply referred to as an “ink composition”) of the invention contains a carbon black pigment and at least one coloring pigment selected from the group consisting of a phthalocyanine pigment, a quinacridone pigment and an azo pigment. At least a part of the surface of the carbon black pigment is coated with a water-insoluble first dispersant polymer containing a structural unit represented by the following formula (1) and a structural unit which is different from the structural unit represented by the following formula (1), and at least a part of the surface of the coloring pigment is coated with the first dispersant polymer or a second dispersant polymer consisting of the same structural units as the structural units constituting the first dispersant polymer but having a composition ratio of the structural units different from the composition ratio of the structural units of the first dispersant polymer.

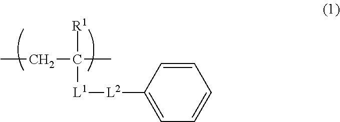

In the formula (1), R¹ represents a hydrogen atom, a methyl group, or a halogen atom, L¹ represents *—COO—, *—OCO—, *—CONR²—, *—O—, or a substituted or unsubstituted phenylene group, and R² represents a hydrogen atom or an alkyl group having 1 to 10 carbon atoms. L² represents a single bond or a divalent linking group having 1 to 30 carbon atoms. Symbol * in L¹ represents a connecting point with the main chain of the polymer.

As in the constitution described above, the black ink composition contains a first dispersant polymer which contains a specific structural unit and is coated on the carbon black pigment for achieving aqueous dispersion of the pigment and a coloring pigment coated with a second dispersant polymer which is similar to the first dispersant polymer or with the first dispersant polymer, and therefore it may form an image with excellent resistance to abrasion and a stable color tone that does not change even after drying.

Further, since the first dispersant polymer contains a specific structural unit, effect of having not only excellent dispersion stability and jetting stability but also excellent resistance to water and resistance to light may be obtained.

[Carbon Black Pigment]

As for the carbon black pigment of the invention, any carbon black pigment that is generally used in the art may be used without specific limitation. Examples of the carbon black pigment include those produced by a known method such as contact method, furnace method, and thermal method.

Specific examples of the carbon black pigment include Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080, Raven 1060, and Raven 700 (trade names, all manufactured by Columbian Carbon), Regal 400R, Regal 330R, Regal 660R, Mogul L, Black Pearls L, Monarch 700, Monarch 800, Monarch 880, Monarch 900, Monarch 1000, Monarch 1100, Monarch 1300, and Monarch 1400 (trade names, all manufactured by Cabot), Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4 (trade names, all manufactured by Degussa), and No. 25, No. 33, No. 40, No. 45, No. 47, No. 52, No. 900, No. 2200 B, No. 2300, MCF-88, MA600, MA7, MA8, and MA100 (trade names, all manufactured by Mitsubishi Chemical Corp.). However, the invention is not limited to them.

The carbon black pigment may be used either singly or in combination of two or more.

[First Dispersant Polymer]

The first dispersant polymer of the invention contains at least one structural unit represented by the following formula (1) (herein below, it may be referred to as a “specific structural unit”) and at least one structural unit which is different from the structural unit represented by the formula (1) (herein below, it may be referred to as an “other structural unit”).

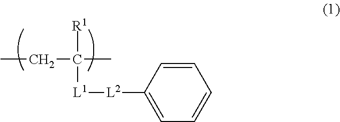

In the formula (1), R¹ represents a hydrogen atom, a methyl group, or a halogen atom (for example, a chlorine atom, a bromine atom, an iodine atom, and the like).

Further, L¹ represents *—COO—, *—OCO—, *—CONR²—, *—O—, or a substituted or unsubstituted phenylene group, and R² represents a hydrogen atom or an alkyl group having 1 to 10 carbon atoms. Further, symbol * in the group represented by L¹ represents a connecting point with the main chain. The substituent group for a substituted phenylene group is not specifically limited. Examples thereof include a halogen atom, an alkyl group, an alkoxy group, a hydroxy group, a cyano group, and the like.

L² represents a single bond or a divalent linking group having 1 to 30 carbon atoms, and in the case of a divalent linking group, a linking group having 1 to 25 carbon atoms is preferable, a linking group having 1 to 20 carbon atoms is more preferable, and a linking group having 1 to 15 carbon atoms is still more preferable. Of these, particularly preferred are an alkylene oxy group having 1 to 25 carbon atoms (more preferably 1 to 10 carbon atoms), an imino group (—NH—), a sulfamoyl group, and a divalent linking group including an alkylene group such as an alkylene group having 1 to 20 carbon atoms (more preferably 1 to 15 carbon atoms) and a polyethylene oxy group [—(CH₂CH₂O)ₙ—, n=1 to 6], and a group in which two or more of these groups are combined.

Among the structural units represented by the formula (1), a structural unit in which R¹ is a hydrogen atom or a methyl group, L¹ is *—COO—, and L² is a divalent linking group having 1 to 25 carbon atoms which contains at least one of an alkylene oxy group or an alkylene group is preferable. A structural unit in which R¹ is a hydrogen atom or a methyl group, L¹ is *—COO—, and L² is *—(CH₂—CH₂—O)ₙ— [n represents an average repeat number, and n=1 to 6] is more preferable.

Among the structural units that are represented by the formula (1), from the viewpoint of dispersion stability, a structural unit derived from a compound selected from the below benzyl methacrylate, phenoxyethylacrylate, and phenoxyethyl methacrylate is preferable. A structural unit derived from a compound selected from phenoxyethylacrylate and phenoxyethyl methacrylate is more preferable. A structural unit derived from phenoxyethyl methacrylate is still more preferable.

The water-insoluble first dispersant polymer of the invention preferably has, as a specific structural unit, one or two or more of the structural units selected from the above. However, the invention is not limited to them.

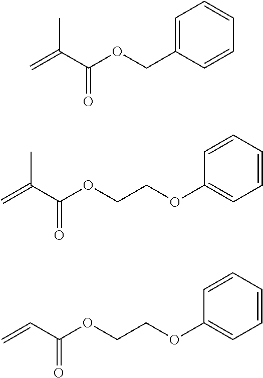

From the viewpoint of dispersion stability of the pigment, jetting stability, and washability, the content ratio of the specific structural unit in the dispersant polymer is preferably 40% by mass or more with respect to the total mass of the dispersant polymer. More preferably, it is 40% by mass or more but less than 75% by mass. Still more preferably, it is 40% by mass or more but less than 70% by mass. Particularly preferably, it is 40% by mass or more but less than 60% by mass.

In addition to the specific structural unit described above, the first dispersant polymer of the invention further contains at least one other structural unit which is different from the specific structural unit. The other structural unit is not specifically limited as long as it may constitute the first dispersant polymer together with a polymerizable compound which constitutes the specific structural unit. Examples thereof include a hydrophobic structural unit having hydrophobic group (provided that, the specific structural unit described above is excluded) and a hydrophilic structural unit having hydrophilic group.

The hydrophobic structural unit (provided that, the specific structural unit described above is excluded) may be formed by polymerization of corresponding monomers. It is also possible that, after preparing a dispersant polymer, a hydrophobic functional group is introduced to the polymer chain.

The monomer which constitutes the hydrophobic structural unit described above (provided that, the specific structural unit described above is excluded) is not specifically limited as long as it has a functional group capable of forming a polymer and a hydrophobic functional group, and any kind of known monomers may be used.

From the viewpoint of availability, handlability, and generality, vinyl monomers ((meth)acrylates, (meth)acrylamides, styrenes, vinyl esters, and the like) are preferred as a monomer which may form the hydrophobic structural unit described above (provided that, the specific structural unit described above is excluded).

Examples of the (meth)acrylates include alkyl(meth)acrylate such as methyl(meth)acrylate, ethyl(meth)acrylate, (iso)propyl(meth)acrylate, (iso or tertiary) butyl(meth)acrylate, 2-ethyl hexyl(meth)acrylate, (iso)octyl(meth)acrylate, (iso)decyl(meth)acrylate, and (iso)stearyl(meth)acrylate. Carbon atom number of alkyl moiety in the alkyl(meth)acrylate is preferably from 1 to 6, more preferably from 1 to 4, and still more preferably from 1 to 2.

In the case that the dispersant polymer contains a structural unit derived from an alkyl ester of (meth)acrylic acid, content ratio of the structural unit in the dispersant polymer is preferably 15% by mass or more with respect to the total mass of the dispersant polymer, from the viewpoint of obtaining dispersion stability. The content ratio of the structural unit is preferably from 20 to 60% by mass, and more preferably from 20 to 50% by mass.

Examples of the (meth)acrylamides include (meth)acrylamide such as N-methyl(meth)acrylamide, N-ethyl(meth)acrylamide, N-propyl(meth)acrylamide, N-isopropyl(meth)acrylamide, N-n-butyl(meth)acrylamide, N-t-butyl(meth)acrylamide, N-cyclohexyl(meth)acrylamide, N-(2-methoxyethyl)(meth)acrylamide, N,N-dimethyl(meth)acrylamide, N,N-diethyl(meth)acrylamide, vinyl (meth)acrylamide, N,N-diallyl(meth)acrylamide, and N-allyl(meth)acrylamide. Of these, (meth)acrylamide and N,N-dimethyl(meth)acrylamide are preferable.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, chloromethylstyrene, hydroxystyrene protected with a group which may be deprotected by an acidic substance (for example, t-Boc or the like), methyl vinyl benzoate, a-methylstyrene, vinyl naphthalene and the like. Styrene and a-methylstyrene are preferable.

Examples of the vinyl esters include vinyl esters such as vinyl acetate, vinyl chloroacetate, vinyl propionate, vinyl butyrate, vinyl methoxyacetate, and vinyl benzoate. Of these, vinyl acetate is preferable.

They may be used either singly or in combination of two or more.

The hydrophilic group in the hydrophilic structural unit described above may be either an ionic group or a non-ionic group.

The hydrophilic structural unit having a hydrophilic group may be obtained by polymerizing a monomer having a hydrophilic group. However, it may also be formed by, after preparing a polymer without a hydrophilic group, introducing a hydrophilic group (an ionic group or a non-ionic group) to the polymer chain.

Examples of the ionic group include an anionic group such as a carboxy group, a sulfonic acid group, and a phosphoric acid group, and a cationic group such as an amino group and an ammonium group. Of these, at least one anionic group selected from a carboxy group, a sulfonic acid group, and a phosphoric acid group is preferable. A carboxy group is more preferable.

Examples of the monomer having an anionic group and the monomer having a cationic group that may be used for the invention are given below. However, the invention is not limited to them.

Examples of the monomer having a carboxy group among the monomers having an anionic group include unsaturated carboxylic acid monomers such as acrylic acid, methacrylic acid, crotonic acid, itaconic acid, maleic acid, fumaric acid, and citraconic acid; and β-carboxy ethyl acrylate, and 2-methacryloyloxy methyl succinate.

Examples of the monomer having a sulfonic acid group include styrene sulfonic acid, 2-acrylamide-2-methylpropane sulfonic acid, 3-sulfopropyl(meth)acrylate, bis-(3-sulfopropyl)-itaconic acid ester, and the like.

Examples of the monomer having a phosphoric acid group include vinyl phosphonic acid, vinyl phosphate, bis(methacryloxyethyl)phosphate, diphenyl-2-acryloyloxyethyl phosphate, diphenyl-2-methacryloyloxyethyl phosphate, dibutyl-2-acryloyloxyethyl phosphate, and the like.

Examples of the monomer having a cationic group include at least one selected from a group consisting of a vinyl monomer having tertiary amine and a vinyl monomer having ammonium salt.

Examples of the vinyl monomer having tertiary amine include N,N-dimethylaminoethyl(meth)acrylate, N,N-dimethylaminopropyl(meth)acrylate, N,N-diethylaminoethyl(meth)acrylate, N,N-dimethylaminopropyl(meth)acrylamide, vinyl pyrrolidone, 2-vinyl pyridine, 4-vinyl pyridine, 2-methyl-6-vinyl pyridine, 5-ethyl-2-vinyl pyridine, and the like.

Examples of the monomer having ammonium salt include quaternized N,N-dimethylaminoethyl(meth)acrylate, quaternized N,N-diethylaminoethyl(meth)acrylate, and quaternized N,N-dimethylaminopropyl(meth)acrylate.

Among them, the anionic monomer is preferable. From the viewpoint of ink viscosity and jetting property, unsaturated carboxylic acid monomer is preferable. Acrylic acid and methacrylic acid are particularly preferable. Further, the monomer having an ionic group may be used either singly or in combination of two or more.

Examples of the non-ionic group include a hydroxy group, an amide group (with a non-substituted nitrogen atom), and an alkylene oxide polymer such as polyethylene oxide and polypropylene oxide described below. Of these, hydroxyethyl(meth)acrylate, hydroxybutyl(meth)acrylate, (meth)acrylamide, and (meth)acrylate containing an alkylene oxide polymer are particularly preferable.

The hydrophilic structural unit described above preferably has a hydrophilic structural unit having an alkylene oxide polymer structure.

From the viewpoint of hydrophobicity, the alkylene in the alkylene oxide polymer described above preferably has carbon atom number of 1 to 6. More preferably, it has carbon atom number of 2 to 6, and particularly preferably carbon atom number of 2 to 4.

The polymerization degree of the alkylene oxide polymer described above is preferably 1 to 120, more preferably from 1 to 60, and particularly preferably from 1 to 30.

It is also a preferred embodiment that the hydrophilic structural unit described above is a hydrophilic structural unit having a hydroxy group. The number of hydroxy group in the hydrophilic structural unit described above is not specifically limited. From the viewpoint of hydrophobicity of a first dispersant polymer and compatibility with a solvent for polymerization and other monomers, it is preferably from 1 to 4, more preferably from 1 to 3, and particularly preferably from 1 to 2.

Content ratio of the hydrophilic structural unit in the dispersant polymer is preferably in the range of more than 0% by mass to 15% by mass, more preferably in the range of 2% by mass to 15% by mass, still more preferably in the range of 5% by mass to 15% by mass, and particularly preferably in the range of 8% by mass to 12% by mass with respect to the total mass of the dispersant polymer.

In the case that the dispersant polymer of the invention contains an anionic group such as a carboxy group, the acid value of the dispersant polymer is preferably from 30 mgKOH/g to 120 mgKOH/g, more preferably from 50 mgKOH/g to 110 mgKOH/g, and particularly preferably from 60 mgKOH/g to 100 mgKOH/g. Herein, the acid value is defined as the mass of KOH (mg) required for complete neutralization of one gram of the polymer, and the method described in JIS standard (JIS K0070: 1992) is used.

In the case that an acid value of the dispersant polymer having an acidic group such as a carboxy group is 30 mgKOH/g or more, dispersibility tends to increase. Further, in the case of 120 mgKOH/g or less, too much increase in the hydrophilicity of the polymer is inhibited, and therefore adsorptivity to carbon black pigment is improved.

The composition ratio of the hydrophilic structural unit and hydrophobic structural unit (including the specific structural unit) varies depending on the degree of hydrophilicity and hydrophobicity of each unit. However, the composition in which the content ratio (mass ratio) of the hydrophobic structural unit in the first dispersant polymer is more than 80% by mass with respect to the total mass of the first dispersant polymer is preferable. The content ratio of the hydrophobic structural unit is more preferably more than 85% by mass. In other words, the content ratio (mass ratio) of the hydrophilic structural unit in the first dispersant polymer is preferably less than 15% by mass with respect to the total mass of the first dispersant polymer. In the case that the content ratio of the hydrophilic structural unit is less than 15% by mass, components that are independently dissolved in an aqueous liquid medium without contributing to dispersion of the pigment are reduced while the pigment is maintained in a good dispersion state and viscosity increase is inhibited, and therefore good jetting property may be provided in the case of use as ink for ink jet recording.

The ratio of aromatic ring contained in the hydrophobic structural unit described above is preferably in the range of 10% by mass or more but less than 20% by mass, and more preferably in the range of 15% by mass or more but less than 20% by mass with respect to the total mass of the polymer. By having the ratio of the aromatic ring in this range, resistance to abrasion, ink stability, and jetting reliability are improved. In other words, in the case that the ratio of the aromatic ring is less than 10% by mass or 20% by mass or more, after a long period of time, precipitation of the dispersion particles (in particular, pigment) may not be inhibited, and a defect associated with white deletion may occur on an image when the ink composition is prepared.

The first dispersant polymer of the invention may be any one of a random copolymer having irregularly introduced structural units and a block copolymer having regularly introduced structural units. In case of a block copolymer, each structural unit may be introduced in any order, and an identical structural unit may be used twice or more. From the viewpoint of generality and producibility, the first dispersant polymer is preferably a random copolymer.

The neutralization degree of the first dispersant polymer in the invention is not specifically limited, but preferably from 50% to 90%. When the neutralization degree is from 50% to 90%, after a long period of time, precipitation of the dispersion particles (in particular, pigment, more particularly azo pigment) is effectively inhibited, and occurrence of white deletion on an image is inhibited when an ink composition is prepared therewith. The neutralization degree of the dispersant polymer is preferably in the range of 72% to 88%.

Solubility of the first dispersant polymer of the invention in water may be from 0.2 g to 0.4 g in 5 mL of water (25° C.). In the case that the solubility is less than 0.2 g or more than 0.4 g, after a long period of time, precipitation of the dispersion particles (in particular, pigment, more particularly azo pigment) may not be inhibited, and a defect associated with white deletion may occur on an image when the ink composition is prepared. The solubility of the first dispersant polymer is preferably in the range of 0.3 g to 0.4 g in 5 mL of water.

For measuring solubility, the first dispersant polymer neutralized to desired neutralization degree is dispersed (ultrasonication for 15 minutes and stirring for 30 minutes) in water (5 mL, 25° C.), and the filtrate obtained by filtering though a filter is quantified by THF-based GPC. The amount of the polymer dissolved in water is taken as a dissolution amount.

Among the above, the first dispersant polymer of the invention preferably has a product of the acid value (mgKOH/g) and the neutralization degree (%) in the range of 5000 to 15000 and a neutralization equivalent of 1 or less. In the case that the product of the acid value and the neutralization degree is 5000 or more, precipitation over a period of time after dispersion of pigment is inhibited, and therefore dispersion stability is good. Further, in the case of 15000 or less, it is advantageous in terms of pigment dispersibility (i.e., micronization of particles). Further, in the case that the neutralization equivalent is 1 or less, pigment may be easily coated with a resin due to the partial neutralization, and coarse particles are reduced. Of the values above, the product of the acid value and the neutralization degree is preferably from 5000 to 9500, and more preferably from 6000 to 9000.

For the same reasons as above, it is preferable that the product of the acid value (mgKOH/g) and the neutralization degree (%) is from 5000 to 9500 (preferably from 6000 to 9000) and the neutralization equivalent is from 0.8 to 0.9.

Molecular weight of the first dispersant polymer of the invention is, in terms of weight average molecular weight (Mw), preferably 30,000 or more, more preferably from 30,000 to 150,000, still more preferably from 30,000 to 100,000, and particularly preferably from 30,000 to 80,000. In the case that the molecular weight is 30,000 or more, steric repulsive effect of a dispersant tends to improve, and due to such steric effect, adsorption onto the pigment easily occur. The number average molecular weight (Mn) is preferably in the range of 1,000 to 100,000 or so, and particularly preferably in the range of 3,000 to 50,000. In the case that the number average molecular weight is within this range, a function as a coating film for the pigment or a function as an application film in ink may be obtained. The first dispersant polymer of the invention is preferably used in the form of alkali metal or organic amine salt.

The molecular weight distribution (weight average molecular weight/number average molecular weight) of the first dispersant polymer is preferably in the range of 1 to 6, and more preferably in the range of 1 to 4. In the case that the molecular weight distribution is within this range, dispersion stability and jetting stability of the ink may be improved.

The number average molecular weight and weight average molecular weight are molecular weights obtained by measurement using GPC analyzer which uses TSKge1 Super Multipore HZ-H column (manufactured by TOSOH Corp.) and by detection using a differential refractometer and THF as a solvent and by conversion with reference to polystyrene as a standard material.

It is preferable that the first dispersant polymer of the invention contains, as the specific structural unit, a structural unit derived from a compound selected from benzyl methacrylate, phenoxyethylacrylate and phenoxyethyl methacrylate in an amount of 40% by mass or more but less than 70% by mass, and as other structural units, a structural unit derived from (meth)acrylic acid alkyl ester in an amount of 20% by mass to 60% by mass and a structural unit derived from acrylic acid or methacrylic acid in an amount of 5% by mass to 15% by mass, and the neutralization degree is from 50% to 90%. More preferably, as the specific structural unit, a structural unit derived from a compound selected from phenoxyethylacrylate and phenoxyethyl methacrylate is contained in an amount of 40% by mass or more but less than 60% by mass, and as other structural units, a structural unit derived from (meth)acrylic acid alkyl ester is contained in an amount of 20% by mass to 50% by mass and a structural unit derived from acrylic acid or methacrylic acid is contained in an amount of 8% by mass to 12% by mass, and the neutralization degree is from 72% to 88%.

The first dispersant polymer may be synthesized according to various polymerization methods such as solution polymerization, precipitation polymerization, suspension polymerization, bulk polymerization, or emulsion polymerization. The polymerization reaction may be performed according to a known operation such as batch type, semi-continuous type, or continuous type operation. Examples of a method of initiating polymerization include a method of using radical initiator, a method of irradiating light or radiation, or the like. These polymerization methods and methods of initiating polymerization are described in literatures including “Method for Polymer Synthesis, Revised Ed., Tsuruta Teiji, published by Nikkan Kogyo Shimbun, Ltd. (1971)” and “Experimental Method for Polymer Synthesis, written by Otsu Takayuki and Kinoshita Masayoshi, published by Kagaku-Dojin Publishing Company, INC, 1972, pages 124 to 154”. Specifically, the dispersant polymer may be produced by copolymerization reaction of a mixture containing a monomer mixture, and if necessary, an organic solvent and a radical initiator under atmosphere of inert gas. Among the polymerization methods, a solution polymerization method which uses a radical initiator is preferable.

Examples of the solvent used for solution polymerization include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. The solvent may be used either singly or in combination of two or more, and further, may be used as a mixture solvent with water. The polymerization temperature needs to be set in view of the molecular weight of the polymer to be produced, type of the initiator, and the like, and is generally in the range of 0° C. to 100° C. or so, but the polymerization is preferably carried out in the temperature range of 50 to 100° C. The reaction pressure may be appropriately selected, but is generally from 1 to 100 kg/cm², and preferably from 1 to 30 kg/cm² or so. The reaction time is from 5 to 30 hours or so. The resin obtained may be purified by reprecipitation, and the like.

Herein below, preferred examples of the first dispersant polymer of the invention are given. However, the first dispersant polymer of the invention is not limited to the following specific examples.

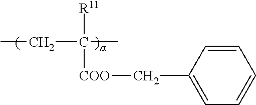

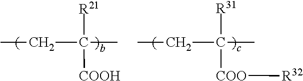

| | R¹¹ | R²¹ | R³¹ | R³² | a | b | c | Mw |
|---|---|---|---|---|---|---|---|---|
| B-1 | CH₃ | CH₃ | CH₃ | —CH₃ | 60 | 10 | 30 | 46000 |
| B-2 | H | H | H | —CH₃ | 60 | 10 | 30 | 50000 |
| B-3 | CH₃ | CH₃ | CH₃ | —CH₂CH₃ | 61 | 10 | 29 | 43000 |
| B-4 | CH₃ | CH₃ | CH₃ | —CH₂CH₂CH₂CH₃ | 61 | 9 | 30 | 51000 |
| B-5 | CH₃ | CH₃ | CH₃ | —CH(CH₃)₂ | 60 | 9 | 31 | 96000 |
| B-6 | H | H | H | —C(CH₃)₃ | 60 | 10 | 30 | 32000 |
| B-7 | CH₃ | CH₃ | CH₃ | —CH₂CH(CH₃)₂ | 70 | 5 | 25 | 75000 |

(a, b, c each represent the content ratio of the unit (% by mass).)

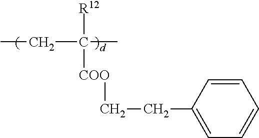

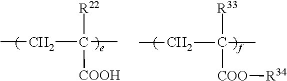

| | R¹² | R²² | R³³ | R³⁴ | d | e | f | Mw |
|---|---|---|---|---|---|---|---|---|
| B-8 | CH₃ | CH₃ | CH₃ | —CH₃ | 55 | 12 | 33 | 31000 |
| B-9 | H | H | H | —CH₂CH(CH₃)₂ | 70 | 10 | 20 | 34600 |

(d, e, f each represent the content ratio of the unit (% by mass).)

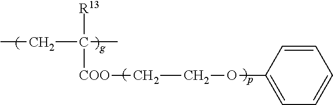

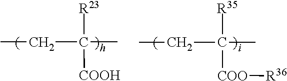

| | R¹³ | p | R²³ | R³⁵ | R³⁶ | g | h | i | Mw |
|---|---|---|---|---|---|---|---|---|---|
| B-10 | CH₃ | 1 | CH₃ | CH₃ | —CH₃ | 60 | 9 | 31 | 35500 |
| B-11 | H | 1 | H | H | —CH₂CH₃ | 69 | 10 | 21 | 41200 |
| B-12 | CH₃ | 2 | CH₃ | CH₃ | —CH₃ | 70 | 11 | 19 | 68000 |
| B-13 | CH₃ | 4 | CH₃ | CH₃ | —CH(CH₃)₂ | 70 | 7 | 23 | 72000 |
| B-14 | H | 5 | H | H | —CH₃ | 70 | 10 | 20 | 86000 |
| B-15 | H | 5 | H | H | —CH₂CH(CH₃)₂ | 70 | 2 | 28 | 42000 |

(g, h, and i each represent the content ratio of the unit (% by mass).)

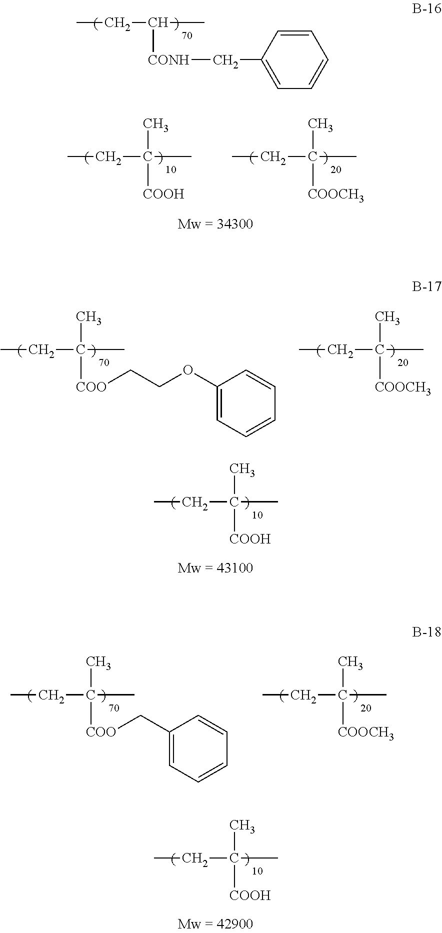

—Ratio Between Carbon Black Pigment and the First Dispersant Polymer—

Ratio between the carbon black pigment (Pig) and the first dispersant polymer (Poly), i.e., (Pig:Poly), is preferably 100:25 to 100:140, and more preferably 100:25 to 100:50 in mass ratio. When the ratio of the first dispersant polymer is increased so that the ratio is 100:25 or more, more favorable dispersion stability and resistance to abrasion are obtained. In addition, in the case that the ratio of the first dispersant polymer is decreased so that the ratio is 100:140 or less, favorable dispersion stability is obtained.

According to the invention, at least a part of the surface of the carbon black pigment particle is coated with the first dispersant polymer. However, the entire surface of the particle may be coated.

The pigment coated with a dispersant polymer is called “encapsulated pigment,” for example, and it may be produced by a conventionally known physical or chemical method. For example, the pigment may be produced according to the methods described in JP-A Nos. 9-151342, 10-140065, 11-209672, 11-172180, 10-25440, and 11-43636. Specifically, the phase inversion emulsification method and the acid precipitation method described in JP-A Nos. 9-151342 and 10-140065 may be mentioned. Of these, the phase inversion emulsification method is preferable from the viewpoint of dispersion stability.

The phase inversion emulsification method is basically a self dispersion (phase inversion emulsification) method in which a melt mixture containing a resin with self dispersibility or dissolution property (i.e., dispersant polymer) and a pigment is dispersed in water. Herein, the melt mixture indicates a state in which components are mixed without being dissolved, a state in which components are dissolved and mixed, or a state having both the states. Specific production method of the “phase inversion emulsification” includes the method described in JP-A No. 10-140065. With regard to more specific methods of the phase inversion emulsification, reference may be made to descriptions of JP-A Nos. 9-151342 and 10-140065.

According to the invention, particle diameter of the carbon black pigment having a particle surface at least partially coated with the first dispersant polymer is not specifically limited. However, from the viewpoint of color tone and resistance to abrasion, the volume average particle diameter is preferably from 65 nm to 110 nm, and more preferably from 70 nm to 100 nm.

The volume average particle diameter is measured by dynamic light scattering method.

The content ratio of the carbon black pigment having a particle surface at least partially coated with the first dispersant polymer in the ink composition of the invention is appropriately selected depending on purpose. Preferably, the content ratio is from 1 to 10% by mass with respect to the whole mass of the ink composition. More preferably, it is from 2 to 8% by mass. Particularly preferably, it is from 2 to 6% by mass.

[Coloring Pigment]

The water-based black ink composition for ink jet recording of the invention contains at least one coloring pigment selected from a group consisting of a phthalocyanine pigment, a quinacridone pigment and an azo pigment, and at least a part of the surface of the coloring pigment particle is coated with at least one of the first dispersant polymer described above or the second dispersant polymer described below. Preferably, at least a part of the particle surface of the coloring pigment described above is coated with the first dispersant polymer described above.

By containing the coloring pigment together with the carbon black pigment described above, an image excellent in color tone and in resistance to abrasion may be formed.

The phthalocyanine pigment, quinacridone pigment, and azo pigment are appropriately selected from known organic pigments. Specific examples of the organic pigments used in the invention are given below.

Examples of the organic pigment for orange or yellow color include C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 127, C. I. Pigment Yellow 128, C. I. Pigment Yellow 138, C. I. Pigment Yellow 151, C. I. Pigment Yellow 155, C. I. Pigment Yellow 180, C. I. Pigment Yellow 185, and the like.

Examples of the organic pigment for magenta or red color include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, C. I. Pigment Red 209, C. I. Pigment Red 222, C. I. Pigment Violet 19, and the like.

Examples of the organic pigment for green or cyan color include C. I. Pigment Blue 15, C. I. Pigment Blue 15:2, C. I. Pigment Blue 15:3, C. I. Pigment Blue 15:4, C. I. Pigment Blue 16, C. I. Pigment Blue 60, C. I. Pigment Green 7, siloxane cross-linked aluminum phthalocyanine described in U.S. Pat. No. 4,311,775, and the like.

Among them, as a phthalocyanine pigment, at least one selected from C. I. Pigment Blue 15:3, C. I. Pigment Blue 15:4, and C. I. Pigment Blue 16 is preferred from the viewpoint of color tone. More preferably, the phthalocyanine pigment is at least one selected from C. I. Pigment Blue 15:3 and C. I. Pigment Blue 15:4.

As a quinacridone pigment, at least one selected from C. I. Pigment Violet 19, C. I. Pigment Red 122, C. I. Pigment Red 209, and Pigment Red 149 is preferred from the viewpoint of color tone. More preferably, the quinacridone pigment is at least one selected from C. I. Pigment Violet 19, C. I. Pigment Red 122, and C. I. Pigment Red 209.

As an azo pigment, at least one selected from C. I. Pigment Yellow 12, C. I. Pigment Yellow 74, C. I. Pigment Yellow 127, C. I. Pigment Yellow 155, and Pigment Yellow 128 is preferred from the viewpoint of color tone. More preferably, the azo pigment is at least one selected from C. I. Pigment Yellow 12, C. I. Pigment Yellow 74, C. I. Pigment Yellow 127, and C. I. Pigment Yellow 155.

The coloring pigment of the invention preferably contains, from the viewpoint of color tone and resistance to abrasion, at least one phthalocyanine pigment. More preferably, the coloring pigment contains at least one phthalocyanine pigment and at least one quinacridone pigment. Still more preferably, it contains at least one phthalocyanine pigment, at least one quinacridone pigment, and at least one azo pigment.

From the viewpoint of color tone and resistance to abrasion, the coloring pigment of the invention preferably contains at least one selected from C. I. Pigment Blue 15:3 and C. I. Pigment Blue 15:4 as a phthalocyanine pigment. More preferably, the coloring pigment contains at least one selected from C. I. Pigment Blue 15:3 and C. I. Pigment Blue 15:4 as a phthalocyanine pigment and at least one selected from C. I. Pigment Violet 19, C. I. Pigment Red 122, and C. I. Pigment Red 209 as a quinacridone pigment. Still more preferably, it contains at least one selected from C. I. Pigment Blue 15:3 and C. I. Pigment Blue 15:4 as a phthalocyanine pigment, at least one selected from C. I. Pigment Violet 19, C. I. Pigment Red 122, and C. I. Pigment Red 209 as a quinacridone pigment, and at least one selected from C. I. Pigment Yellow 12, C. I. Pigment Yellow 74, C. I. Pigment Yellow 127, and C. I. Pigment Yellow 155 as an azo pigment.

[Second Dispersant Polymer]

The second dispersant polymer of the invention consists of the same structural units as the structural units constituting the first dispersant polymer described above, but the composition ratio of the structural units of the second dispersant polymer is different from that of the first dispersant polymer. Thus, the second dispersant polymer has a structural characteristic which is similar to that of the first dispersant polymer.

The second dispersant polymer of the invention is not specifically limited as long as the composition ratio of the structural units constituting the second dispersant polymer is different from the composition ratio of the structural units constituting the first dispersant polymer.

The difference in composition ratio of the structural units between the first dispersant polymer and the second dispersant polymer is not specifically limited. However, the difference is preferably appropriately selected so that the second dispersant polymer is a preferred embodiment of the first dispersant polymer.

Coating of the coloring pigment with the second dispersant polymer may be carried out according to the method of coating the carbon black pigment with the first dispersant polymer described above. The preferred embodiments are also the same.

According to the invention, particle diameter of the coloring pigment having a particle surface at least partially coated with the second dispersant polymer is not specifically limited. However, from the viewpoint of color tone and resistance to abrasion, the volume average particle diameter is preferably from 60 nm to 140 nm, and more preferably from 70 nm to 98 nm.

According to the invention, in the case that the coloring pigment having a particle surface at least partially coated with the second dispersant polymer is dispersed in a water-based medium (preferably, water), the pH is preferably from 7 to 10, and more preferably from 8 to 9.5, from the viewpoint of preparing an ink therefrom.

In the ink composition of the invention, the total content ratio of the coloring pigment having a particle surface at least partially coated with the second dispersant polymer is appropriately selected depending on the purpose. From the viewpoint of color tone and resistance to abrasion, it is preferably from 0.1 to 10% by mass, more preferably from 0.2 to 7.5% by mass, and particularly preferably from 0.3 to 5% by mass with respect to the total mass of the carbon black pigment.

When a phthalocyanine pigment and a quinacridone pigment are contained as a coloring pigment, their content ratio may be appropriately selected. From the viewpoint of color tone and resistance to abrasion, it is preferable that the phthalocyanine pigment is contained in an amount of 0.1 to 4.0 parts by mass and the quinacridone pigment is contained in an amount of 0.1 to 3.0 parts by mass with respect to 100 parts by mass of the carbon black pigment. It is more preferable that the phthalocyanine pigment is contained in an amount of 0.3 to 3.0 parts by mass and the quinacridone pigment is contained in an amount of 0.3 to 2.0 parts by mass.

Further, in the case that the phthalocyanine pigment, the quinacridone pigment, and the azo pigment are contained as a coloring pigment, their content ratio may be appropriately selected. From the viewpoint of color tone and resistance to abrasion, it is preferable that the phthalocyanine pigment is contained in an amount of 0.1 to 4.0 parts by mass, the quinacridone pigment is contained in an amount of 0.1 to 3.0 parts by mass, and the azo pigment is contained in an amount of 0.1 to 2.0 parts by mass with respect to 100 parts by mass of the carbon black pigment. It is more preferable that the phthalocyanine pigment is contained in an amount of 0.3 to 3.0 parts by mass, the quinacridone pigment is contained in an amount of 0.2 to 2.0 parts by mass, and the azo pigment is contained in an amount of 0.2 to 1.0 parts by mass.

The water-based black ink composition for ink jet recording of the invention preferably contains the carbon black pigment coated with the first dispersant polymer and the coloring pigment containing at least the phthalocyanine pigment and quinacridone pigment coated with the first dispersant polymer or second dispersant polymer wherein the total content ratio of the coloring pigment is from 0.1 to 10% by mass with respect to the content of the carbon black pigment.

More preferably, the composition contains the carbon black pigment coated with the first dispersant polymer and the coloring pigment containing the phthalocyanine pigment, quinacridone pigment, and azo pigment coated with the first dispersant polymer wherein the total content ratio of the coloring pigment is from 0.1 to 10% by mass with respect to the content of the carbon black pigment.

Still more preferably, the composition contains the carbon black pigment coated with the first dispersant polymer and, as a phthalocyanine pigment, at least one selected from C. I. Pigment Blue 15:3 and C. I. Pigment Blue 15:4 coated with the first dispersant polymer, as a quinacridone pigment, at least one selected from C. I. Pigment Violet 19, C. I. Pigment Red 122, and C. I. Pigment Red 209, and as an azo pigment, at least one selected from C. I. Pigment Yellow 12, C. I. Pigment Yellow 74, C. I. Pigment Yellow 127, and C. I. Pigment Yellow 155 wherein the total content ratio of the coloring pigment is from 0.2 to 7.5% by mass with respect to the content of the carbon black pigment.

[Aqueous Medium]

The water-based black ink composition for ink jet recording of the invention contains an aqueous medium. The aqueous medium contains at least water, and if necessary, it further contains at least one water-soluble organic solvent.

The amount of water is not specifically limited. The content of water is preferably from 10 to 99% by mass, more preferably from 30 to 80% by mass, and still more preferably from 50 to 70% by mass.

(Water-Soluble Organic Solvent)

The ink composition of the invention preferably contains at least one water-soluble organic solvent. With the water-soluble organic solvent, an effect of preventing dryness, moisturizing, or promoting penetration may be obtained. For preventing dryness, it is used as an agent for preventing dryness which inhibits clogging caused by the occurrence of aggregates that are formed by the ink composition adhered and dried at an ink jetting opening of a jetting nozzle. For preventing dryness or moisturizing, a water-soluble organic solvent which has lower vapor pressure than water is preferable. Further, for promoting penetration, it may be used as an agent for promoting penetration to increase penetration of the ink into a paper.

Examples of the water-soluble organic solvent include alkane diols (i.e., polyhydric alcohols) such as glycerin, 1,2,6-hexanetriol, trimethylol propane, ethylene glycol, propylene glycol, diethylene glycol, triethylene glycol, tetraethylene glycol, pentaethylene glycol, dipropylene glycol, 2-butene-1,4-diol, 2-ethyl-1,3-hexane diol, 2-methyl-2,4-pentanediol, 1,2-octane diol, 1,2-hexane diol, 1,2-pentanediol, and 4-methyl-1,2-pentanediol; alkyl alcohols having 1 to 4 carbon atoms such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, tripropylene glycol monomethyl ether, dipropylene glycol mono-n-propyl ether, and dipropylene glycol mono-iso-propyl ether; 2-pyrrolidone; N-methyl-2-pyrrolidone; and the like. It may be used either singly or in combination of two or more.

For the purpose of preventing dryness or moisturizing, polyhydric alcohols are useful. Examples thereof include glycerin, ethylene glycol, diethylene glycol, triethylene glycol, propylene glycol, dipropylene glycol, tripropylene glycol, 1,3-butanediol, 2,3-butanediol, and the like. It may be used either singly or in combination of two or more.

For the purpose of promoting penetration, polyol compounds are preferable. The aliphatic diols are suitable. Examples of the aliphatic diols include 2-ethyl-2-methyl-1,3-propanediol, 3,3-dimethyl-1,2-butanediol, 2,2-diethyl-1,3-propanediol, 2-ethyl-1,3-hexane diol, 2,2,4-trimethyl-1,3-pentanediol, and the like. Of these, 2-ethyl-1,3-hexane diol and 2,2,4-trimethyl-1,3-pentanediol are the preferred examples.

The water-soluble organic solvent may be used either singly or in combination of two or more.

The content of the water-soluble organic solvent in the ink composition is, from the viewpoint of having stability and jetting reliability, preferably from 1 to 60% by mass, more preferably from 5 to 40% by mass, and particularly preferably from 10% by mass to 30% by mass in the whole ink composition.

(Surfactant)

The ink composition of the invention preferably contains at least one surfactant.

The surfactant is used as an agent for controlling surface tension, and examples thereof include a non-ionic, a cationic, an anionic, and a betaine-type surfactant. The surfactant is preferably contained in an amount which allows control of surface tension of the ink composition within the range of 20 to 60 mN/m. With the amount of this range, droplets may be favorably applied by ink jet method. The content of the surfactant in the ink composition is preferably an amount which allows control of surface tension within the range of 20 to 45 mN/m. More preferably, it is an amount which allows control of surface tension within the range of 25 to 40 mN/m.

As for the surfactant, a compound having both a hydrophilic moiety and a hydrophobic moiety in the same molecule, and the like are suitable. Any of an anionic surfactant, a cationic surfactant, an amphoteric surfactant, and a non-ionic surfactant may be used. Specific examples of the anionic surfactant include, among hydrocarbons, an anionic type surfactant such as fatty acid salt, alkyl sulfate ester salt, alkylbenzene sulfonate ester salt, alkylnaphthalene sulfonate ester salt, dialkylsulfosunnic acid salt, alkylphosphporic acid ester salt, naphthalene sulfonic acid formalin condensate, and polyoxyethylene alkyl sulfate ester salt; and a non-ionic type surfactant such as polyoxyethylene alkyl ether, polyoxyethylene alkylaryl ether, polyoxyethylene fatty acid ester, sorbitan fatty acid ester, polyoxyethylene sorbitan fatty acid ester, polyoxyethylene alkylamine, glycerin fatty acid ester, and oxyethylene oxypropylene block copolymer. Further, SURFYNOLS (trade name, manufactured by Air Products & Chemicals) and OLFINE (trade name, manufactured by Nissin Chemical Industry CO., Ltd.), each of which is an acetylene-based polyoxyethylene oxide surfactant, are also preferably used. Further, an amine oxide type amphoteric surfactant such as N,N-dimethyl-N-alkylamine oxide is also preferable.

The surfactants described in JP-A No. 59-157636 (pages (37) to (38)) or Research Disclosure No. 308119 (1989) may be also used.

By using the fluorine-based (i.e., fluoroalkyl-based) surfactant and the silicone-based surfactant disclosed in JP-A Nos. 2003-322926, 2004-325707, and 2004-309806, the resistance to abrasion may be further improved.

The content of the surfactant in the ink composition is not specifically limited. It is preferably 1% by mass or more, more preferably from 1 to 10% by mass, still more preferably from 1 to 3% by mass.

(Other Components)

In addition to the components described above, if necessary, the ink composition may further contain various additives as other components. Examples of the various additives include a known additive such as a UV absorbing agent, an anti-discoloration agent, an antifungal agent, a pH controlling agent, an anti-corrosion agent, an anti-oxidant, an emulsification stabilizer, a preservative, an anti-foaming agent, a viscosity controlling agent, a dispersion stabilizer, a chelating agent, a solid humectant, and the like.

Examples of the solid humectant include sugars such as glucose, mannose, fructose, ribose, xylose, arabinose, galactose, aldonic acid, glucitol, maltose, cellobiose, lactose, sucrose, trihalose, and maltotriose; sugar alcohols; hyaluronic acids; ureas; and the like.

—Physical Property of Ink—

The surface tension (25° C.) of the ink composition is preferably from 20 mN/m to 60 mN/m. More preferably, it is from 20 mN to 45 mN/m, and still more preferably from 25 mN/m to 40 mN/m. The surface tension is obtained by measuring ink at 25° C. condition by using Automatic Surface Tensiometer CBVP-Z (trade name, manufactured by Kyowa Interface Science Co., Ltd).

The viscosity of the ink composition at 25° C. is preferably from 1.2 mPa·s to 15.0 mPa·s, more preferably 2 mPa·s or more but less than 13 mPa·s, and still more preferably 2.5 mPa·s or more but less than 10 mPa·s. The viscosity is obtained by measuring ink at 25° C. condition by using VISCOMETER TV-22 (trade name, manufactured by TOKI SANGYO CO. LTD).

<Image Forming Method>

The image forming method of the invention has at least an ink application step in which the ink composition of the invention is applied to a recording medium by ink jet method and a treatment liquid application step in which a treatment liquid containing an acidic compound to aggregate components of the ink composition is applied to a recoding medium. If necessary, the image forming method of the invention may further has other steps such as fixing step. By forming an image by using the ink composition of the invention, an image having no defect associated with white deletion and excellent in color tone and in resistance to abrasion is obtained.

—Ink Application Step—

In the ink application step, the ink composition of the invention is applied by jetting by ink jet method to form an image on a recording medium. The ink jet method may be any method of jetting an ink composition for ink jet recording as a droplet from a nozzle and adhering the droplet onto a recording medium.

When forming an image by ink jet method, the ink composition is jetted on a recording medium by applying energy, thereby forming a colored image. As an ink jet recording method which is preferred for the invention, the method described in paragraph Nos. 0093 to 0105 in JP-A No. 2003-306623 may be used.

The ink jet method is not specifically limited, and any known method such as a charge control method of jetting ink by using electrostatic attractive force, a drop-on-demand method (i.e., pressure pulse method) using vibration energy of a piezo element, an acoustic ink jet method of jetting ink by using radiation pressure after an electric signal converted into a sound beam is applied to ink, and a thermal ink jet method to form bubbles by heating ink and using the pressure generated therefrom may be employed. As an ink jet method, the ink jet method described in JP-A No. 54-59936 where an ink received heat energy is rapidly changed in volume and the ink is jetted from a nozzle by an action force due to this change may be effectively used, in particular.

The ink jet method may be a method of jetting a lot of small volume of ink with low concentration, which is called photo ink, a method of using a plural ink having substantially the same color but with different concentration to improve image quality, or a method of using colorless and, transparent ink.

The recording medium is not specifically limited, and examples include a regular paper, a high quality paper, a coated paper, and the like. The coated paper is prepared by forming a coating layer on the surface of a high quality paper, a neutral paper or the like according to application of a coating material thereon, wherein the high quality paper, neutral paper or the like is mostly made of cellulose and generally does not have a treated surface. When an image is formed by using aqueous ink jet method which generally uses a coated paper as a recording medium, a quality problem in image bleeding and resistance to abrasion, may easily occur. However, according to the image forming method of the invention, image bleeding is inhibited and unevenness in density is prevented, and an image with excellent resistance to abrasion may be obtained.

Commercially available coated paper may be used, and a coated paper for general use in printing may be used. Specific examples include a coated paper (A2 and B2) such as “OK TOPCOAT+” (trade name, manufactured by Oji Paper Company, Limited) and “AURORA COAT” and “U LIGHT” (trade names, manufactured by Nippon Paper Industries Co., Ltd.), an art paper (A1) such as “TOKUBISHI ART” (trade name, manufactured by Mitsubishi Paper Mills Limited), and the like.

—Treatment Liquid Application Step—

In the treatment liquid application step, a treatment liquid containing an acidic compound which aggregates components of the ink composition applied during the ink application step is applied to a recording medium. By brining the treatment liquid into contact with the ink composition, the components of the ink composition are aggregated so that the image forming may be performed at higher speed.

As for the method of applying the treatment liquid on a recording medium, it may be any one of a method of applying in image shape and a method of applying in plane shape. A well-known liquid application method may be used without limitation. Examples include application according to ink jet method, application using a coating roller, and the like.

The application amount of the treatment liquid is not specifically limited as long as it is within the range in which the ink composition is aggregated. It may be appropriately selected depending on application method. In case of a treatment liquid containing an acidic compound, it is preferably an amount to achieve that the application amount of acidic compound is 0.3 g/m² or more, more preferably from 0.3 g to 2 g/m², and still more preferably from 0.5 to 1 g/m².

Examples of the treatment liquid containing an acidic compound include a liquid which may generate an aggregate by changing pH of the ink composition. From the viewpoint of the aggregation speed of the ink composition, pH of the treatment liquid (at 25° C.) is preferably 3.5 or less, more preferably from 0.5 to 2.5, and still more preferably from 0.5 to 1.5. In such case, pH of the ink composition (at 25° C.) used for the ink application step is preferably 7.5 or more (more preferably, 8 or more).

Specifically, in the invention, from the viewpoint of image density, resolution, and high-speed image forming, it is preferable that pH of the ink composition (at 25° C.) is 8 or more, and pH of the treatment liquid (at 25° C.) is 3.5 or less (preferably, from 0.5 to 2.5).

The aggregation component may be used either singly or in combination of two or more.

As for the acidic compound, a compound having a phosphoric acid group, a phosphonic acid group, a phosphinic acid group, a sulfuric acid group, a sulfonic acid group, a sulfinic acid group, or a carboxy group, or their salt may be used. Of these, from the viewpoint of aggregation speed of the ink composition, a compound having a phosphoric acid group or a carboxy group is more preferable. A compound having a carboxy group is still more preferable.

The compound having a carboxy group is preferably selected from, for example, polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, ortho phosphoric acid, pyrrolidone carboxylic acid, pyron carboxylic acid, pyrrol carboxylic acid, furan carboxylic acid, pyridine carboxylic acid, coumaric acid, thiophene carboxylic acid, nicotinic acid, or derivatives of these compounds, or their salt. The compound may be used either singly or in combination of two or more.

The treatment liquid may include a water-based solvent (for example, water and a water-soluble organic solvent) in addition to the acidic compound. The content of the acidic compound in the treatment liquid is, from the viewpoint of aggregation effect, preferably from 5 to 95% by mass and more preferably from 10 to 80% by mass with respect to the total mass of the treatment liquid.

The treatment liquid may contain other additives within the range that the effect of the invention is not impaired. Examples of the other additives include a known additive such as an anti-dryness agent (i.e., a humectant), an anti-discoloration agent, an emulsification stabilizer, a penetration promoter, a UV absorbent, a preservative, an antifungal agent, a pH controlling agent, a surface tension controlling agent, an anti-foaming agent, a viscosity controlling agent, a dispersant, a dispersion stabilizer, an anti-corrosion agent, and a chelating agent. Those exemplified above as a specific example of other additives that are included in the aqueous ink for ink jet recording may be also used.

Viscosity of the treatment liquid is, from the viewpoint of the aggregation speed of the ink composition, preferably in the range of 1 to 30 mPa·s, more preferably in the range of 1 to 20 mPa·s, still more preferably in the range of 2 to 15 mPa·s, and particularly preferably in the range of 2 to 10 mPa·s. The viscosity is measured at 20° C. condition by using VISCOMETER TV-22 (trade name, manufactured by TOKI SANGYO Co. Ltd.).

Surface tension of the treatment liquid is, from the viewpoint of the aggregation speed of the ink composition, preferably from 20 to 60 mN/m, more preferably from 20 to 45 mN/m, and still more preferably from 25 to 40 mN/m. The surface tension is measured at 25° C. condition by using Automatic Surface Tensiometer CBVP-Z (trade name, manufactured by Kyowa Interface Science Co., Ltd.).

According to the invention, it is preferable that the ink application step is performed after the treatment liquid is applied during the treatment liquid application step. Specifically, it is preferable that the treatment liquid for aggregating the components in the ink composition (in particular, dispersion particles such as pigment or polymer particles included in the ink composition) is applied to a recording medium in advance before applying the ink composition and then an image is formed by applying the ink composition so that it is brought into contact with the treatment liquid applied on a recording medium. As a result, high-speed ink jet recording may be achieved, and an image with high resolution and density is obtained even when high-speed recording is performed.

The recorded matter that is formed by using the ink composition of the invention has excellent image quality and also excellent color tone and resistance to abrasion.

According to an aspect of the invention, there are provided the following embodiments <1> to <11>.

<1> A water-based black ink composition for ink jet recording comprising:

a carbon black pigment, at least a part of a surface of the carbon black pigment being coated with a water-insoluble first dispersant polymer containing a structural unit represented by the following formula (1) and a structural unit different from the structural unit represented by the following formula (1);

at least one coloring pigment selected from the group consisting of a phthalocyanine pigment, a quinacridone pigment and an azo pigment, at least a part of a surface of the at least one coloring pigment being coated with the first dispersant polymer or a second dispersant polymer consisting of the same structural units as the structural units constituting the first dispersant polymer but having a composition ratio of the structural units different from a composition ratio of the structural units of the first dispersant polymer; and

an aqueous medium:

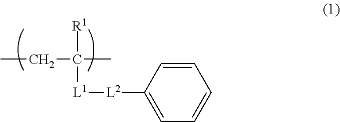

wherein R¹ represents a hydrogen atom, a methyl group, or a halogen atom; L¹ represents *—COO—, *—OCO—, *—CONR²—, *—O—, or a substituted or unsubstituted phenylene group; R² represents a hydrogen atom or an alkyl group having 1 to 10 carbon atoms; L² represents a single bond or a divalent linking group having 1 to 30 carbon atoms; and the symbol * in the group represented by L¹ represents a connecting point with a main chain of the first dispersant polymer.

<2> The water-based black ink composition for ink jet recording according to <1>, wherein each of the first dispersant polymer and the second dispersant polymer contains an anionic group.
<3> The water-based black ink composition for ink jet recording according to <2>, wherein acid values of the first dispersant polymer and the second dispersant polymer are each independently from 30 mgKOH/g to 120 mgKOH/g.
<4> The water-based black ink composition for ink jet recording according to any one of <1> to <3>, wherein a total content ratio of the at least one coloring pigment with respect to the carbon black pigment is from 0.1% by mass to 10% by mass.
<5> The water-based black ink composition for ink jet recording according to any one of <1>to <4>, wherein the at least one coloring pigment is derived from a water-based dispersion of coloring particles, and a pH of the water-based dispersion is from 7 to 10.
<6> The water-based black ink composition for ink jet recording according to any one of <1> to <5>, wherein the phthalocyanine pigment is at least one selected from the group consisting of C. I. Pigment Blue 15:3 and C. I. Pigment Blue 15:4.
<7> The water-based black ink composition for ink jet recording according to any one of <1> to <6>, wherein the quinacridone pigment is at least one selected from the group consisting of C. I. Pigment Violet 19, C. I. Pigment Red 122, and C. I. Pigment Red 209.
<8> The water-based black ink composition for ink jet recording according to any one of <1> to <7>, wherein the azo pigment is at least one selected from the group consisting of C. I. Pigment Yellow 12, C. I. Pigment Yellow 74, C. I. Pigment Yellow 127, and C. I. Pigment Yellow 155.
<9> The water-based black ink composition for ink jet recording according to any one of <1> to <8>, wherein a volume average particle diameter of the at least one coloring pigment is from 60 nm to 140 nm.
<10> The water-based black ink composition for ink jet recording according to any one of <1> to <9>, wherein the at least one coloring pigment contains at least the phthalocyanine pigment and the quinacridone pigment.
<11> An image forming method comprising:

applying the water-based black ink composition for ink jet recording according to any one of <1> to <10> onto a recording medium by an ink jet method; and

applying a treatment liquid onto the recoding medium, the treatment liquid containing an acidic compound that aggregates a component of the water-based black ink composition for ink jet recording when brought into contact with the water-based black ink composition for ink jet recording.

According to the invention, a water-based black ink composition for ink jet recording which enables forming of an image with excellent color tone and resistance to abrasion and an image forming method using the composition are provided.

### EXAMPLES

Herein below, the invention is explained in greater detail in view of the Examples. However, the invention is not limited to the Examples. Unless otherwise indicated specifically, “%” and “parts” are based on mass.

The weight average molecular weight was measured by gel permeation chromatography (GPC). For GPC, HLC-8020 GPC (trade name, manufactured by TOSOH Corp.) was used and three columns of TSK gel Super Multipore HZ-H (trade name, manufactured by TOSOH Corp., 4.6 mmID×15 cm) were used. The eluent used was THF (tetrahydrofuran). The measurement conditions were sample concentration of 0.45% by mass, flow rate of 0.35 mL/min, sample injection amount of 10 μL, and measurement temperature of 40° C., and an RI detector was used. Calibration curve was established with eight samples of “Standard sample TSK standard, polystyrene”: “F-40,” “F-20,” “F-4,” “F-1,” “A-5000,” “A-2500,” “A-1000,” and “n-propyl benzene” (trade names, all manufactured by TOSOH Corp.).

[Synthesis of Dispersant Polymer]

### Synthesis Example 1

### Synthesis of Dispersant Polymer D-1

To a 500 mL three-neck flask equipped with a stirrer and a condensing tube, 33 g of methyl ethyl ketone was added and heated at 75° C. under nitrogen atmosphere. A solution of dimethyl 2,2′-azobisisobutyrate (2 g), phenoxyethyl methacrylate (50 g), methacrylic acid (8 g), and methyl methacrylate (42 g) dissolved in methyl ethyl ketone (70 g) was added dropwise thereto over three hours. Once the dropwise addition was completed, the reaction was carried out for additional one hour, and then a solution of dimethyl 2,2′-azobisisobutyrate (0.2 g) dissolved in methyl ethyl ketone (2 g) was added. After increasing the temperature to 78° C., the mixture was heated for 4 hours. The reaction solution obtained was reprecipitated twice with excess hexane. The precipitated polymer was dried to obtain 95 g of dispersant polymer B-1.

Composition of the polymer obtained was confirmed by ¹H-NMR and the weight average molecular weight (Mw) measured by GPC was 40,800. Acid value of the polymer was measured according to the method described in JIS standard (JIS K0070: 1992), and it was found to be 52.1 mgKOH/g.

### Synthesis Example 2

### Synthesis of Dispersant Polymers D-2 to D-9

Dispersant polymers were synthesized in the same manner as the Synthesis example 1 except that the monomer used for synthesis in the Synthesis example 1 was changed to those described in Table 1 for the respective polymers. As a result, the dispersant polymers D-2 to D-9 (i.e., resin dispersant) were obtained.

The molecular weight was controlled by adjusting the addition amount of dimethyl 2,2′-azobisisobutyrate (initiator). Further, the monomer values given in the table are the content ratios (%) based on mass.

TABLE 1

| | | | | | | | | | Weight | |
|---|---|---|---|---|---|---|---|---|---|---|
| | Specific structural unit | | | | | Other structural units | | | average | Acid |
| Dispersant | Monomer | Monomer | Monomer | Monomer | Monomer | Methyl | Methacrylic | Monomer | molecular | value |
| polymer | 1 | 2 | 3 | 4 | 5 | methacrylate | acid | 6 | weight | (mgKOH/g) |
| D-1 | 50 | — | — | — | — | 42 | 8 | — | 40800 | 52.1 |
| D-2 | 50 | — | — | — | — | 39 | 11 | — | 38000 | 71.7 |
| D-3 | 50 | — | — | — | — | 35 | 15 | — | 39000 | 97.8 |
| D-4 | 50 | — | — | — | — | 30 | 20 | — | 42000 | 130.4 |
| D-5 | — | — | — | — | — | 25 | 25 | 50 | 30000 | 162.9 |
| D-6 | — | 50 | — | — | — | 35 | 15 | — | 35000 | 97.8 |
| D-7 | — | — | 50 | — | — | 35 | 15 | — | 31900 | 97.8 |
| D-8 | — | — | — | 50 | — | 35 | 15 | — | 42800 | 97.8 |
| D-9 | — | — | — | — | 50 | 35 | 15 | — | 36800 | 97.8 |

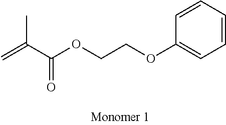

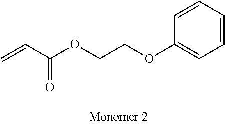

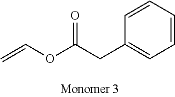

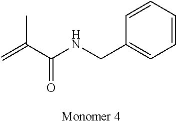

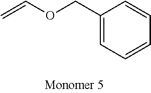

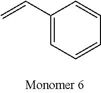

[Production of Water-Based Black Ink Composition for Ink Jet Recording]

(1) Preparation of Ink Composition 2

—Preparation of Resin-Coated Carbon Black Pigment Dispersion—

10 parts of carbon black pigment (trade name: PRINTEX300, manufactured by Degussa), 6.5 parts of the dispersant polymer D-1 obtained above, 16 parts of methyl ethyl ketone, 8 parts of 1 Mol/l NaOH aqueous solution, and 59.5 parts of ion exchange water were mixed and dispersed. The mixture was subjected to eight passes by a disperser (trade name: MICROFLUIDIZER M-140K (150 MPa), manufactured by MIZUHO Industrial CO., LTD.). From the dispersion obtained, methyl ethyl ketone was removed at 55° C. under reduced pressure. Further, by removing some water, a carbon black pigment dispersion having pigment concentration of 15.5% by mass was obtained. After the centrifugation at 5000 rpm for 30 minutes by using a centrifuge (05 P-21, manufactured by Hitachi, Ltd.), ion exchange water was added to give the pigment concentration of 15% by mass. Consequently, the pigment dispersion (K-1) was prepared.

Ion exchange water (10 mL) was added to the pigment dispersion obtained above (10 μL) to give a sample for measurement. By using a Nanotrac particle size distribution analyzer UPA-EX150 (trade name, manufactured by Nikkiso Co., Ltd.), D95 particle diameter was measured at 25° C. based on dynamic scattering method, and it was found to be 85 nm. The D95 particle diameter indicates particle diameter when cumulative particle diameter distribution (based on volume) is 95% at small particle diameter side.

Further, pH of the pigment dispersion obtained was measured with a pH meter WM-50 EG (trade name, manufactured by DKK-TOA Corp.), and it was found to be 8.4.

—Preparation of Resin-Coated Phthalocyanine Pigment Dispersion—

10 parts of a phthalocyanine pigment (C. I. Pigment Blue 15:3, manufactured by BASF Japan), 6.5 parts of the dispersant polymer D-1 obtained above, 20 parts of methyl ethyl ketone, 8 parts of 1 Mol/l NaOH aqueous solution, and 55.5 parts of ion exchange water were mixed and dispersed. The mixture was subjected to eight passes by a disperser (trade name: MICROFLUIDIZER M-140K (150 MPa), manufactured by MIZUHO Industrial CO., LTD.). From the dispersion obtained, methyl ethyl ketone was removed at 55° C. under reduced pressure. Further, by removing some water, a phthalocyanine pigment dispersion having pigment concentration of 15.5% by mass was obtained. After the centrifugation at 5000 rpm for 30 minutes by using a centrifuge (05 P-21, manufactured by Hitachi, Ltd.), ion exchange water was added to give the pigment concentration of 15% by mass. Consequently, the pigment dispersion (C-1) was prepared.

—Preparation of Resin-Coated Quinacridone Pigment Dispersion—

Resin-coated quinacridone pigment dispersion (M-1) was prepared in the same manner as the preparation of a resin-coated phthalocyanine pigment dispersion above except that a quinacridone pigment (C. I. Pigment Red 122, manufactured by BASF Japan) was used instead of a phthalocyanine pigment.

—Preparation of Resin-Coated Azo Pigment Dispersion—

Resin-coated azo pigment dispersion (Y-1) was prepared in the same manner as the preparation of a resin-coated phthalocyanine pigment dispersion above except that an azo pigment (C. I. Pigment Yellow 74, manufactured by Dainichiseika Color & Chemicals Mfg. Co., Ltd.) was used instead of a phthalocyanine pigment.

—Preparation of Ink Composition 2—

By using the pigment dispersions (K-1, C-1, M-1, and Y-1) obtained above, a pigment dispersion-containing composition having the ink composition as follows was prepared. The composition was centrifuged (10000 to 20000 rpm, for 30 minutes to 2 hours) to give the ink composition 2.

<Composition of Ink>

| | | |
|---|---|---|
| Pigment dispersion (K-1) | 2.0 | parts |
| Pigment dispersion (C-1) | 0.007 | parts |
| Pigment dispersion (M-1) | 0.05 | parts |
| Pigment dispersion (Y-1) | 0.024 | parts |
| Glycerin | 7 | parts |
| Diethylene glycol | 9 | parts |
| Triethanolamine | 1 | part |
| OLFINE E1010 (trade name, manufactured by | 1 | part |
| Nissin Chemical Industry Co., Ltd.) | | |
| Tripropylene glycol monomethyl ether | 9 | parts |
| (SP value = 20.4) | | |
| Ion exchange water | 34 | parts |

pH of the ink composition 2 obtained was measured with pH meter WM-50 EG (trade name, manufactured by DKK-TOA Corp.), and it was found to be 8.65.

(2) Preparation of Ink Compositions 1 and 3 to 28

Ink compositions 1 and 3 to 28 were prepared in the same manner as the preparation of ink composition 2 above except that the dispersant polymer D-1 was changed to each of the dispersant polymers shown in the Table 2 below, the phthalocyanine pigment, quinacridone pigment, and azo pigment were changed to the pigments shown in the Table 2 below, and addition amount of each of the coloring pigment dispersions was changed to the amount described in the Table 2 below.

[Preparation of Treatment Liquid]

By mixing the components below, the treatment liquid was prepared. pH of the treatment liquid (25° C.) was measured with pH meter WM-50 EG (trade name, manufactured by DKK-TOA Corp.), and it was found to be 1.21.

<Composition>

| | | |
|---|---|---|
| Malonic acid (acidic compound) | 7.5 | g |
| SANNIX GP250 (trade name, manufactured by Sanyo Chemical | 10 | g |
| Industries, Ltd., polypropylene glycol glyceryl ether) | | |
| Ion exchange water | 7.5 | g |

[Evaluation]

(Image Forming)

The ink composition obtained above was loaded in an ink jet printer (600 dpi, print head with 256 nozzles). On FX-L paper (trade name, manufactured by Fuji Xerox Company) as a recording medium, the treatment liquid obtained above was coated with coating amount of 2.7 g/m², and the ink composition was jetted by the ink jet printer above. As a result, 100% coverage pattern was formed.

(Color Tone)

—1. Color Tone Change (Hue Change)—

Color tone was evaluated as follows. The results are given in the Table 2.

By using an ink jet printer (600 dpi, print head with 256 nozzles), a grey solid image was formed on an ink receiving layer of each ink jet recording sheet (i.e., third ink receiving layer). At that time, grey scale of image data was adjusted so as to obtain the grey density of 1.7, as measured by Gretag Spectrolino SPM-50 (trade name, manufactured by GretagMacbeth, view angle; 2°, light source; D50, no filter)

The sheets were overlaid so that the solid image-formed surfaces faced each other, and then kept for one day at room temperature. Right after the printing (i.e., within three minutes after printing) and one day after the printing and overlaying, L*a*b* was measured for each grey solid image by using spectrophotometer Spectrolino (trade name, manufactured by GretagMacbeth) with condition including a viewing angle of 2°, a light source of F8, and no filter. From each measured value, color difference (ΔE) was obtained and taken as an index for evaluating color tone change. The evaluation was made from the color difference according to the following evaluation criteria.

—Evaluation Criteria—

A: ΔE<2; Color tone change was hardly recognized.
B: 2≦ΔE<4; Color tone change was found, but not easily recognized visually.
C: 4≦ΔE<7; Color tone change was easily recognized visually.
D: ΔE≧7; Color tone change was significant.

(Resistance to Abrasion)

Resistance to abrasion was evaluated as follows. The results are given in the Table 2.

—Resistance to Abrasion—

Right after printing a 2 cm×2 cm square size of the solid area, the recording medium on which the solid image had been printed was overlaid with an unrecorded recording medium (i.e., a recording medium which is the same as the one used for recording (herein below, referred to as “unused sample” in the present evaluation)), and rubbed back and forth ten times with a load of 150 kg/m² applied. After that, degree of ink transfer on white portion of the unused sample was visually examined and evaluated according to the following criteria.

—Evaluation Criteria—

A: No ink transfer was recognized at all.
B: Ink transfer was hardly recognized visually.
C: Slight ink transfer was recognized.
D: Ink transfer was significant.

TABLE 2

| | Ink composition | | | | | | | | | | | |
|---|---|---|---|---|---|---|---|---|---|---|---|---|
| | | Pigment dispersion contained | | | | | | | | | | |
| | | | | | | | | Content (with | | | | |
| | | | | Particle | | Phthalo- | | respect to CB | Particle | | Quina- | |
| | | Carbon black | Dispersant | diameter | | cyanine | Dispersant | content) [% | diameter | | cridone | Dispersant |
| | No. | pigment | polymer | [nm] | pH | pigment | polymer | by mass] | [nm] | pH | pigment | polymer |
| Ex 1 | 1 | PrinteX 300 | D-1 | 87 | 8.6 | PB15:3 | D-1 | 0.40 | 90 | 8.7 | PR.122 | D-1 |
| Ex 2 | 2 | PrinteX 300 | D-1 | 85 | 8.4 | PB15:3 | D-1 | 0.35 | 95 | 8.8 | PR.122 | D-1 |
| Ex 3 | 3 | PrinteX 300 | D-1 | 75 | 8.6 | PB15:3 | D-2 | 0.65 | 91 | 8.6 | PR.122 | D-1 |
| Ex 4 | 4 | PrinteX 300 | D-1 | 80 | 8.5 | PB15:3 | D-2 | 0.70 | 86 | 8.6 | PR.122 | D-2 |
| Ex 5 | 5 | PrinteX 300 | D-2 | 72 | 8.7 | PB15:3 | D-2 | 0.68 | 90 | 8.4 | PR.122 | D-2 |
| Ex 6 | 6 | PrinteX 300 | D-1 | 75 | 8.4 | PB15:3 | D-2 | 0.50 | 88 | 8.2 | PR.122 | D-3 |
| Ex 7 | 7 | PrinteX 300 | D-1 | 81 | 8.3 | PB15:3 | D-2 | 0.30 | 96 | 8.6 | PR.122 | D-3 |
| Ex 8 | 8 | PrinteX 300 | D-3 | 83 | 8.5 | PB15:3 | D-2 | 1.80 | 82 | 8.5 | PR.122 | D-3 |
| Ex 9 | 9 | PrinteX 300 | D-4 | 82 | 8.6 | PB15:3 | D-2 | 0.46 | 83 | 8.9 | PR.122 | D-3 |
| Ex 10 | 10 | PrinteX 300 | D-1 | 88 | 8.1 | PB15:3 | D-3 | 0.35 | 98 | 8.8 | PR.122 | D-3 |
| Ex 11 | 11 | PrinteX 300 | D-4 | 84 | 8.6 | PB15:3 | D-3 | 0.88 | 87 | 8.8 | PR.122 | D-2 |
| Ex 12 | 12 | PrinteX 300 | D-4 | 72 | 8.4 | PB15:3 | D-4 | 0.90 | 99 | 8.7 | PR.122 | D-3 |
| Ex 13 | 13 | PrinteX 300 | D-3 | 79 | 8.3 | PB15:3 | D-4 | 0.44 | 89 | 8.6 | PR.122 | D-3 |
| Ex 14 | 14 | PrinteX 300 | D-1 | 80 | 8.8 | PB15:4 | D-2 | 0.68 | 90 | 8.4 | PV.19 | D-2 |
| Ex 15 | 15 | PrinteX 300 | D-2 | 72 | 8.4 | PB15:4 | D-2 | 1.50 | 88 | 8.7 | PV.19 | D-3 |
| Ex 16 | 16 | PrinteX 300 | D-1 | 75 | 8.6 | PB15:4 | D-2 | 1.80 | 96 | 8.8 | PV.19 | D-3 |
| Ex 17 | 17 | PrinteX 300 | D-1 | 81 | 8.6 | PB15:4 | D-2 | 2.20 | 82 | 8.9 | PV.19 | D-3 |
| Ex 18 | 18 | PrinteX 300 | D-3 | 83 | 8.7 | PB15:4 | D-2 | 2.50 | 83 | 8.6 | PV.19 | D-3 |
| Ex 19 | 19 | PrinteX 300 | D-6 | 80 | 8.5 | PB15:3 | D-6 | 0.70 | 86 | 8.6 | PR.122 | D-6 |
| Ex 20 | 20 | PrinteX 300 | D-7 | 80 | 8.5 | PB15:3 | D-7 | 0.70 | 86 | 8.6 | PR.122 | D-7 |
| Ex 21 | 21 | PrinteX 300 | D-8 | 80 | 8.5 | PB15:3 | D-8 | 0.70 | 86 | 8.6 | PR.122 | D-8 |
| Ex 22 | 22 | PrinteX 300 | D-9 | 80 | 8.5 | PB15:3 | D-9 | 0.70 | 86 | 8.6 | PR.122 | D-9 |
| Comp. | 23 | PrinteX 300 | D-1 | 86 | 8.5 | PB15:3 | D-1 | 0.45 | 92 | 8.8 | PR.122 | D-5 |
| Ex 1 | | | | | | | | | | | | |
| Comp. | 24 | PrinteX 300 | D-1 | 83 | 8.5 | PB15:6 | D-5 | 1.80 | 82 | 8.1 | PR.122 | D-3 |
| Ex 2 | | | | | | | | | | | | |
| Comp. | 25 | PrinteX 300 | D-6 | 79 | 8.3 | PB15:3 | D-4 | 0.44 | 89 | 8.6 | PR.122 | D-3 |
| Ex 3 | | | | | | | | | | | | |
| Comp. | 26 | PrinteX 300 | D-2 | 72 | 9.8 | PB15:3 | D-7 | 11.00 | 90 | 8.4 | PR.122 | D-2 |
| Ex 4 | | | | | | | | | | | | |
| Comp. | 27 | PrinteX 300 | D-5 | 72 | 9.8 | PB15:3 | D-5 | 11.00 | 90 | 8.4 | PR.122 | D-5 |
| Ex 5 | | | | | | | | | | | | |
| Comp. | 28 | PrinteX 300 | D-6 | 88 | 10.5 | PB15:3 | D-7 | 0.35 | 98 | 8.8 | PR.122 | D-8 |
| Ex 6 | | | | | | | | | | | | |

| | Ink composition | | | | | | | | | |
|---|---|---|---|---|---|---|---|---|---|---|
| | Pigment dispersion contained | | | | | | | | | |
| | Content (with | | | | | Content (with | | | | |
| | respect to CB | Particle | | | | respect to CB | Particle | | Evaluation | |
| | content) [% | diameter | | Azo | Dispersant | content) [% | diameter | | Color | Resistance |
| | by mass] | [nm] | pH | pigment | polymer | by mass] | [nm] | pH | tone | to abrasion |
| Ex 1 | 0.26 | 80 | 8.5 | — | — | — | — | — | A | B |
| Ex 2 | 2.50 | 76 | 8.5 | PY74 | D-1 | 1.20 | 87 | 8.2 | B | B |
| Ex 3 | 1.50 | 85 | 8.6 | PY74 | D-1 | 1.30 | 85 | 8.8 | B | B |
| Ex 4 | 2.20 | 90 | 8.1 | PY74 | D-1 | 0.25 | 89 | 8.6 | A | A |
| Ex 5 | 0.68 | 92 | 8.6 | PY74 | D-2 | 0.64 | 98 | 8.7 | B | A |
| Ex 6 | 0.97 | 75 | 8.3 | PY74 | D-3 | 0.34 | 102 | 8.1 | A | A |
| Ex 7 | 0.15 | 81 | 8.3 | PY74 | D-4 | 0.98 | 98 | 8.6 | A | B |
| Ex 8 | 0.30 | 72 | 8.5 | PY74 | D-3 | 0.46 | 89 | 8.2 | A | A |
| Ex 9 | 0.55 | 79 | 8.2 | PY74 | D-4 | 0.75 | 95 | 8.8 | A | B |
| Ex 10 | 1.90 | 82 | 8.7 | PY74 | D-4 | 0.88 | 84 | 8.6 | A | A |
| Ex 11 | 1.85 | 69 | 8 | PY74 | D-1 | 0.23 | 100 | 8.8 | B | A |
| Ex 12 | 2.00 | 89 | 8.6 | PY74 | D-4 | 0.24 | 93 | 8.1 | B | A |
| Ex 13 | 0.89 | 88 | 8.3 | PY74 | D-1 | 0.87 | 86 | 8 | A | A |
| Ex 14 | 0.75 | 92 | 8.4 | PY155 | D-2 | 1.20 | 101 | 8.3 | B | B |
| Ex 15 | 0.69 | 75 | 8.8 | PY155 | D-3 | 0.30 | 98 | 8.5 | A | A |
| Ex 16 | 0.54 | 81 | 8.8 | PY155 | D-4 | 1.61 | 96 | 8.5 | B | B |
| Ex 17 | 2.00 | 72 | 8.6 | PY155 | D-3 | 0.80 | 97 | 8.4 | A | A |
| Ex 18 | 1.30 | 79 | 8.4 | PY155 | D-4 | 1.80 | 88 | 8.6 | B | B |
| Ex 19 | 1.75 | 90 | 8.1 | PY74 | D-6 | 0.25 | 89 | 8.6 | B | B |
| Ex 20 | 1.60 | 90 | 8.1 | PY74 | D-7 | 0.25 | 89 | 8.6 | B | B |
| Ex 21 | 1.40 | 90 | 8.1 | PY74 | D-8 | 0.25 | 89 | 8.6 | B | B |
| Ex 22 | 1.70 | 90 | 8.1 | PY74 | D-9 | 0.25 | 89 | 8.6 | B | B |
| Comp. | 2.50 | 76 | 8 | PY74 | D-1 | 1.20 | 98 | 8 | C | B |
| Ex 1 | | | | | | | | | | |
| Comp. | 0.30 | 72 | 8.5 | PY74 | D-3 | 0.46 | 89 | 8.2 | C | B |
| Ex 2 | | | | | | | | | | |
| Comp. | 0.89 | 88 | 8.3 | PY2 | D-1 | 0.87 | 86 | 8 | B | C |
| Ex 3 | | | | | | | | | | |
| Comp. | 0.68 | 92 | 8.6 | PY74 | D-2 | 0.64 | 98 | 0.5 | D | C |
| Ex 4 | | | | | | | | | | |
| Comp. | 0.68 | 92 | 8.6 | PY74 | D-5 | 0.64 | 98 | 0.5 | D | C |
| Ex 5 | | | | | | | | | | |
| Comp. | 1.90 | 82 | 8.7 | PY74 | D-9 | 0.88 | 84 | 0.5 | D | D |
| Ex 6 | | | | | | | | | | |

From the Table 2, it is found that the image formed with the water-based black ink composition for ink jet recording of the invention has excellent color tone and excellent resistance to abrasion.

All publications, patent applications, and technical standards mentioned in this specification are herein incorporated by reference to the same extent as if each individual publication, patent application, or technical standard was specifically and individually indicated to be incorporated by reference.

What is claimed is:

1. A water-based black ink composition for ink jet recording comprising:
a carbon black pigment, at least a part of a surface of the carbon black pigment being coated with a water-insoluble first dispersant polymer containing a structural unit represented by the following formula (1) and a structural unit different from the structural unit represented by the following formula (1);
at least one coloring pigment selected from the group consisting of a phthalocyanine pigment, a quinacridone pigment and an azo pigment, at least a part of a surface of the at least one coloring pigment being coated with the first dispersant polymer or a second dispersant polymer consisting of the same structural units as the structural units constituting the first dispersant polymer but having a composition ratio of the structural units different from a composition ratio of the structural units of the first dispersant polymer; and
an aqueous medium: 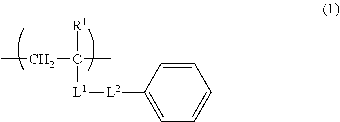
wherein R¹ represents a hydrogen atom, a methyl group, or a halogen atom; L¹ represents *—COO—, *—OCO—, *—CONR²—, *—O—, or a substituted or unsubstituted phenylene group; R² represents a hydrogen atom or an alkyl group having 1 to 10 carbon atoms; L² represents a single bond or a divalent linking group having 1 to 30 carbon atoms; and the symbol * in the group represented by L¹ represents a connecting point with a main chain of the first dispersant polymer.

2. The water-based black ink composition for ink jet recording according to claim 1, wherein each of the first dispersant polymer and the second dispersant polymer contains an anionic group.

3. The water-based black ink composition for ink jet recording according to claim 2, wherein acid values of the first dispersant polymer and the second dispersant polymer are each independently from 30 mgKOH/g to 120 mgKOH/g.

4. The water-based black ink composition for ink jet recording according to claim 1, wherein a total content ratio of the at least one coloring pigment with respect to the carbon black pigment is from 0.1% by mass to 10% by mass.

5. The water-based black ink composition for ink jet recording according to claim 1, wherein the at least one coloring pigment is derived from a water-based dispersion of coloring particles, and a pH of the water-based dispersion is from 7 to 10.

6. The water-based black ink composition for ink jet recording according to claim 1, wherein the phthalocyanine pigment is at least one selected from the group consisting of C. I. Pigment Blue 15:3 and C. I. Pigment Blue 15:4.

7. The water-based black ink composition for ink jet recording according to claim 1, wherein the quinacridone pigment is at least one selected from the group consisting of C. I. Pigment Violet 19, C. I. Pigment Red 122, and C. I. Pigment Red 209.

8. The water-based black ink composition for ink jet recording according to claim 1, wherein the azo pigment is at least one selected from the group consisting of C. I. Pigment Yellow 12, C. I. Pigment Yellow 74, C. I. Pigment Yellow 127, and C. I. Pigment Yellow 155.

9. The water-based black ink composition for ink jet recording according to claim 1, wherein a volume average particle diameter of the at least one coloring pigment is from 60 nm to 140 nm.

10. The water-based black ink composition for ink jet recording according to claim 1, wherein the at least one coloring pigment contains at least the phthalocyanine pigment and the quinacridone pigment.

11. An image forming method comprising:
applying the water-based black ink composition for ink jet recording according to claim 1 onto a recording medium by an ink jet method; and
applying a treatment liquid onto the recoding medium, the treatment liquid containing an acidic compound that aggregates a component of the water-based black ink composition for ink jet recording when brought into contact with the water-based black ink composition for ink jet recording.
